(19) United States
(12) Patent Application Publication
(10) Pub. No.: US 2020/0151795 A1
(43) Pub. Date: May 14, 2020

(54) SYSTEM AND METHOD FOR PROVIDING PRODUCT AND SERVICE RECOMMENDATIONS

(71) Applicant: Mark Figliulo, New York, NY (US)

(72) Inventor: Mark Figliulo, New York, NY (US)

(21) Appl. No.: 16/191,433

(22) Filed: Nov. 14, 2018

(51) Int. Cl. G06Q 30/06; G06F 7/02

(52) U.S. Cl. CPC G06Q 30/0631; G06F 7/02

(57) ABSTRACT

Embodiments of the present invention generally relate to systems and methods of facilitating purchasing decisions regarding products or services by providing product and service ratings and recommendations. Specifically, this invention relates to a system and method of synthesizing a variety of data regarding products and services to provide a comprehensive score that consumers can use to guide their purchase decisions.

### FIELD OF THE INVENTION

Embodiments of the present invention generally relate to systems and methods of providing product and service reviews and recommendations. Specifically, this invention relates to a system and method of synthesizing a variety of data regarding products and services to provide a score that consumers can use to guide their purchase decisions.

### BACKGROUND OF THE INVENTION

As the variety of products and services available to consumers becomes larger and the ease with which they are accessible increases, consumers are faced with purchasing decisions ever more often. However, many such decisions are complicated by the number of similar and competing goods and services and the overwhelming amount of information from disparate sources that one has to analyze in order to decide which particular product or service to purchase.

When faced with such decisions, customers often seek sources of information that are more authoritative or reliable than a product manufacturer or seller or a service provider. However, the sheer volume of information available for some products and services along with the inconsistencies in the information provided often lead to frustration and indecision, making a purchasing decision all the more time-consuming and difficult. While certain sources of information about products and services are more reliable than others for some subset of products and services, they may not be as reliable for others and therefore do not provide a consistently reliable approach that customers can use. Although some customers attempt to rely on more than one source of information, they typically end up relying on incomplete, inaccurate, or outright biased information.

Therefore, there is a need in the art for a system and method of providing product and service recommendations that combine and synthesize multiple sources of information to arrive at a trustworthy product or service rating. Customers would benefit from a method and system that provides a holistic evaluation of a product or service that accounts for a plurality of perspectives of shopping information based on a reliable measurement of that product or service achieved through an objective analysis of a variety of tangible and intangible factors that may impact a customer's purchasing decision. These and other features and advantages of the present invention will be explained and will become obvious to one skilled in the art through the summary of the invention that follows.

### SUMMARY OF THE INVENTION

Accordingly, embodiments of the present invention are directed to systems and methods that synthesize a variety of data from a plurality of sources to provide a reliable rating of a product or service, hereinafter referred to as a Quid Score™. Embodiments of the present invention may combine sub-scores within sub-categories to arrive at the Quid Score™. More specifically the system of an embodiment of the present invention weighs and averages an Expert Score, a Customer Score, a Brand Score and a Retail Value Index into a single number presented as the Quid Score™ for a given product or service.

According to an embodiment of the present invention, the Expert Score comprises the cumulative average score of every well-respected and reputable expert review input into the system for a given product or service. While every individual source of information may be subjective, the combination and averaging ameliorate the effects of the bias.

According to an embodiment of the present invention, the Customer Score comprises the cumulative average score of every customer review input into the system for a given product or service. Generally, the selected customer reviews include those from well-known online retailers, big-box retailers, as well as those from mom-and-pop shops, where available.

According to an embodiment of the present invention, the Brand Score comprises an evaluation measuring a brand's heritage, innovation, reliability, social good, and relevance. Factors taken into account by this evaluation include a brand's website popularity rankings, social footprint, corporate responsibility, and brand sentiment. Also, according to an embodiment of the present invention, the Retail Value Index for a given product or service is produced by indexing the lowest price for such a product or service relative to the average price of the entire category of products or services to which the product or service in question belongs.

Finally, from the combination of the Expert Score, the Customer Score, the Brand Score and the Retail Value Index, according to an embodiment of the present invention, the system provides a Quid Score™ to be relied upon by a customer in making a purchasing decision with respect to a product or service. In this manner the system provides an easy and convenient as well as trustworthy reference for purchasing decisions that saves time and eliminates a significant amount of frustration and hassle for the customer.

In accordance with an embodiment of the present invention the provision of the Quid Score™ comprises the steps of obtaining and categorizing information from a plurality of sources; analyzing, weighing, averaging, and combining the information to produce the relevant sub-scores for each of the Expert Score, the Customer Score, the Brand Score and the Retail Value Index; and then analyzing, weighing, averaging, and combining the sub-scores to produce the Quid Score™. The sub-steps of this method are described in more detail below. In accordance with an embodiment of the present invention this method may be implemented on a computing device or a network of computing devices comprising a non-transitory computer readable medium discussed more particularly below.

According to a preferred embodiment of the present invention, a system for facilitating purchasing decisions comprises a data source, a data synthesis module, a non-transitory computer readable medium, and a means of displaying visual information to a user. In an exemplary embodiments the data source may be a data server or a hard-drive. In some embodiments the data synthesis module comprises, a processor, a random access memory circuit, and a data storage medium. In other alternative embodiments, the data synthesis module comprises: a computing device comprising a processor, and the non-transitory computer readable medium comprising computer program instructions.

According to another preferred embodiment of the present invention, a system for facilitating purchasing decisions comprises a data source, a data synthesis module, a means of displaying visual information to a user, and a non-transitory computer readable medium that, in turn, comprises computer program instructions directing the data synthesis module to perform the steps of: obtaining a Brand Score, obtaining an Expert Score, obtaining a Customer Score, obtaining a Retail Value Index, generating a Comprehensive Score based on one or more of the Brand Score, Expert Score, Customer Score, and Retail Value Index, and displaying at least one of a Comprehensive Score, a Top 10 products list within a product category, or a product recommendation to a user.

According to another preferred embodiment of the present invention, a method for facilitating a purchase decision comprises the steps of: obtaining a Brand Score, obtaining an Expert Score, obtaining a Customer Score, obtaining a Retail Value Index, and generating a Comprehensive Score. The method, according to alternative embodiments of the present invention, may further comprise the step of generating a top 10 product list for a product category as well as the step of generating at least one product recommendation. Other embodiments of the invention may comprise the step of displaying the Comprehensive Score to a user and also optionally comprise the step of displaying at least one of the Brand Score, the Expert Score, the Customer Score, and the Retail Value Index. In some embodiments, the step of obtaining the Brand Score comprises the steps of: assigning a weight factor to each of a heritage rating, an innovation rating, a reliability rating, a social good rating, and a relevance rating; multiplying each weight factor by the rating associated with it, and multiplying the sum of the resulting values. In preferred embodiments of the present invention, the step of obtaining the Expert Score comprises the steps of: assigning a numerical value on a predetermined standardized quantitative scale for each Expert review and rating available from one or more data sources, and computing the average of the numerical values. In a preferred embodiment, the step of obtaining the Customer Score comprises the steps of: assigning a numerical value on a predetermined standardized quantitative scale for each Customer review and rating available from one or more data sources; and computing the average of the numerical values. Likewise, in a preferred embodiment of the present invention, the step of obtaining the Retail Value Index comprises the steps of: identifying a lowest purchase price available for a product within a set of price data; obtaining an average price for all products in the same product category from the set of price data; subtracting the lowest purchase price of the product from the average price of all the products; dividing a result of the subtraction by the average price; adding 1 to a result of the division; and dividing the result of the summation by a predetermined scaling factor. Additionally, the step of generating the Comprehensive Score comprises the steps of: assigning a weight factor to each of the Brand Score, the Expert Score, the Customer Score, and the Retail Value Index; multiplying each respective weight factor by the score or index to which it was assigned; and adding the values resulting after the multiplication, in the preferred embodiments of the present invention.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3 is a diagram of an exemplary method in accordance with an embodiment of the present invention;

FIG. 4 is a diagram of an exemplary method in accordance with an embodiment of the present invention;

FIG. 5 is a diagram of an exemplary method in accordance with an embodiment of the present invention;

FIG. 6 is a diagram of an exemplary method in accordance with an embodiment of the present invention;

FIG. 7 is a diagram of an exemplary method in accordance with an embodiment of the present invention; and

FIG. 8 is a diagram of an exemplary method in accordance with an embodiment of the present invention.

### DETAILED DESCRIPTION

In the Summary above and in this Detailed Description, and the claims below, and in the accompanying drawings, reference is made to particular features of various embodiments of the invention. It is to be understood that the disclosure of embodiments of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

It should be noted that the features and elements illustrated in the drawings are not necessarily drawn to scale, and features or elements of one embodiment may be employed with other embodiments as the skilled artisan would recognize, even if not explicitly stated herein. Descriptions of well-known components and processing techniques may be omitted so as to not unnecessarily obscure the embodiments.

In the present disclosure, various features may be described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

In the present disclosure, all embodiments where “comprising” is used may have as alternatives “consisting essentially of,” or “consisting of.” In the present disclosure, any method or apparatus embodiment may be devoid of one or more process steps or components. In the present disclosure, embodiments employing negative limitations are expressly disclosed and considered a part of this disclosure. The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components. References in the singular form include the plural, and vice versa, unless logically inconsistent or otherwise noted.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

The present invention generally relates to systems and methods of providing product and service reviews and recommendations. Specifically, this invention relates to a system for and method of synthesizing a variety of data regarding products and services to provide a score and recommendation that consumers can use to guide their purchase decisions. For the sake of clarity, in the present disclosure the words “product” and “service” may be used interchangeably and with either of “product” and “service” being understood to mean “product”, “service”, or “product or service”, whereby “product” may be understood as “service” and “service” may be understood as “product” unless logically inconsistent or otherwise noted. Additionally, in the present disclosure the word “brand” should be understood to be interchangeable with “company” most closely associated with such brand and vice versa unless logically inconsistent or otherwise noted. Lastly it should be noted that in the present disclosure and claims the phrases “Quid Score™” and “Comprehensive Score” may likewise be used interchangeably.

According to an embodiment of the present invention, a system is comprised of a data source, a data synthesis module, a non-transitory computer readable medium, and a means of displaying visual information to a user. A preferred embodiment of the present invention comprises a data source, a data synthesis module comprising a non-transitory computer readable medium containing instructions for performing the methods described herein, and a computing device capable of displaying visual information to a user.

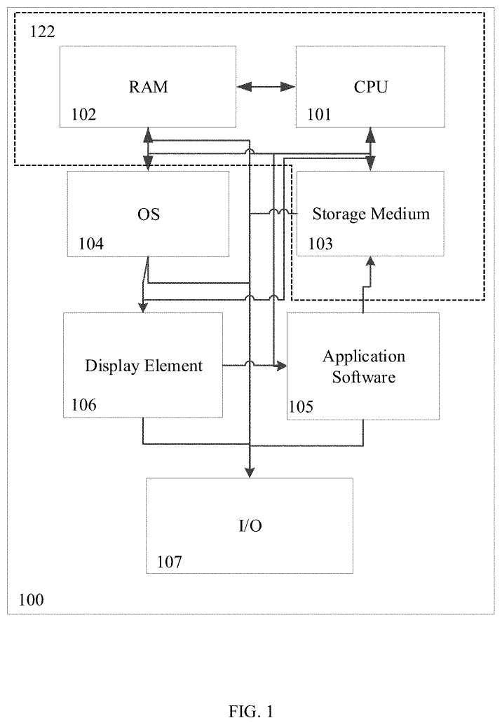

An illustrative representation of a computing device appropriate for use with embodiments of the system of the present disclosure is shown in FIG. 1. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, and servers. Multiple computing devices can be operably linked to form a computer network in a manner as to distribute and share one or more resources, such as clustered computing devices and server banks/farms.

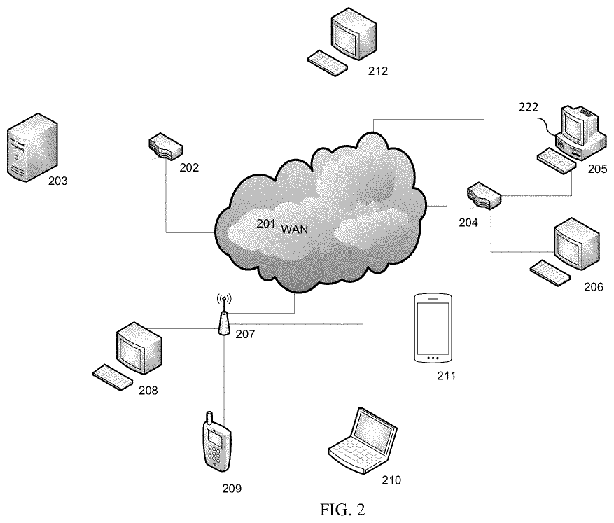

Various examples of such general-purpose multi-unit computer networks suitable for embodiments of the disclosure, their typical configuration and many standardized communication links are well known to one skilled in the art, as explained in more detail and illustrated by FIG. 2, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 2, a schematic overview of a system in accordance with an embodiment of the present disclosure is shown. The system is comprised of one or more data servers 203 for electronically receiving, storing, and providing information used by the system. Applications or programs in the server 203 may retrieve and manipulate information in storage devices and exchange information through a WAN 201 (e.g., the Internet). Applications or programs in server 203 may also be used to manipulate information stored remotely and process and analyze data stored remotely across a WAN 201 (e.g., the Internet).

According to an exemplary embodiment, as shown in FIG. 2, an exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system (i) through a computing device 212 directly connected to the WAN 201, (ii) through a computing device 205, 206 connected to the WAN 201 through a routing device 204, (iii) through a computing device 208, 209, 210 connected to a wireless access point 207 or (iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

Traditionally, a computer application or program includes a finite sequence of computational instructions or program instructions. It will be appreciated that a programmable apparatus or computing device can receive such a computer application or program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the functions and methods described or depicted herein. This particular machine (or networked configuration thereof) provides a technique for carrying out any and all of the functions and methods described or depicted herein.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like. The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

A preferred embodiment of the present invention comprises at least one data source, a data synthesis module comprising a non-transitory computer readable medium containing instructions for performing the methods described herein with the data synthesis module configured to execute the instructions thereof, and a computing device capable of displaying visual information to a user, each directly or indirectly communicatively connected to another. These components may be discrete elements of the system or, alternatively, some of the components may be contained within other components or comprise elements of other components. For example, as depicted in FIG. 2, in accordance with an embodiment of the present invention, the data source may be a stand-alone data server 203 that is communicatively connected via the internet 201 to a data synthesis module 222 comprising a computing device 205 comprising a processor and computer program instructions stored on a non-transitory computer readable medium which module is then, in turn, connected to a smart phone 211 capable of displaying visual information to a user via its screen. In another exemplary embodiment, the data source may be a hard-drive storage medium 103 of a personal computer that contains computer program instructions and is electrically connected to the CPU 101 and RAM 102 of the computer wherein the CPU, RAM, and hard drive, in-part, form the data synthesis module 122, as shown in FIG. 1; and the computing device capable of displaying visual information may be a computer display communicatively connected to a computer tower and the remaining components housed therein.

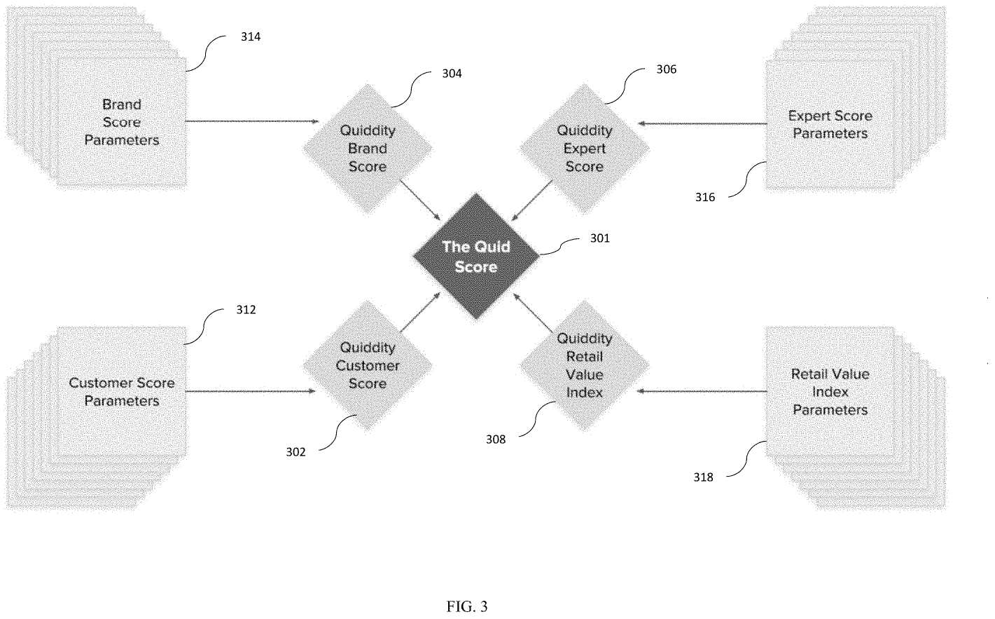

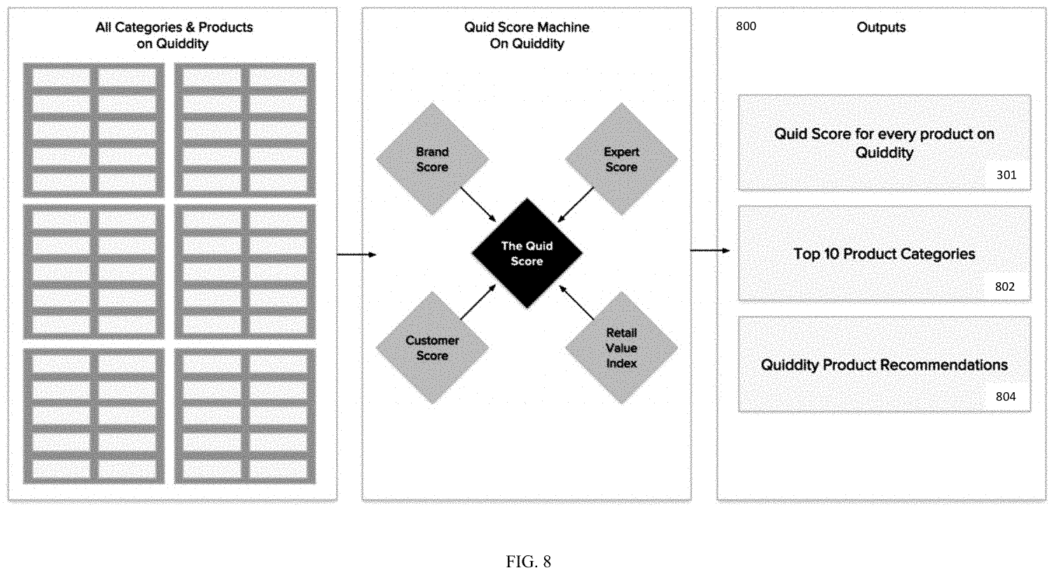

According to an embodiment of the present invention, as shown in FIGS. 3 and 8, a method for facilitating a purchase decision for a given product may comprise the steps of obtaining a Brand Score 304; obtaining an Expert Score 306; obtaining a Customer Score 302; obtaining a Retail Value Index 308; generating a Quid Score™ 301 based on a conversion of or some combination of the Brand Score, Expert Score, Customer Score, and Retail Value Index; and displaying at least one of the Brand Score, Expert Score, Customer Score, Retail Value Index and Quid Score™ as an output 800 to a user. In an alternative embodiment, a method for facilitating a purchase decision for a given product may also comprise the steps of generating a Top 10 product list 804 for a given category based on at least one of the Brand Score, Expert Score, Customer Score, Retail Value Index and Quid Score™ obtained for each product and displaying it to a user. In yet another embodiment of the present invention, a method for facilitating a purchase decision for a given product may further comprise the step of generating one or more product recommendation 804 and displaying it to a user.

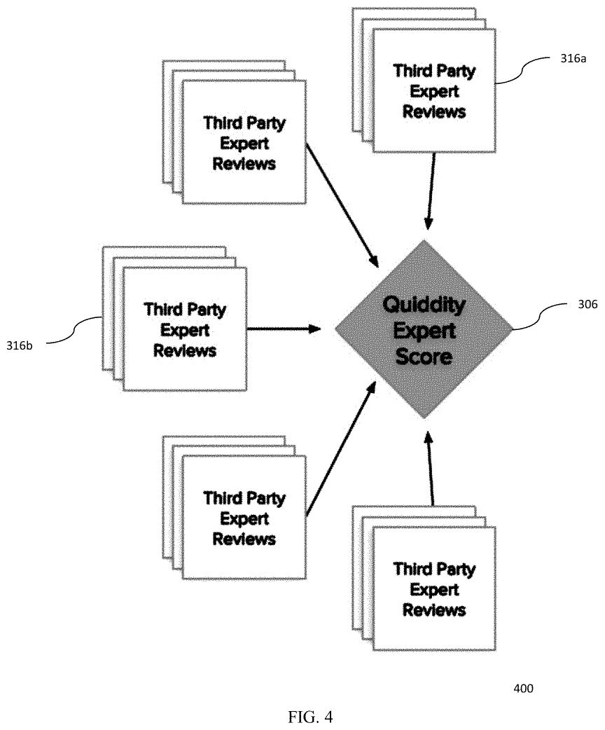

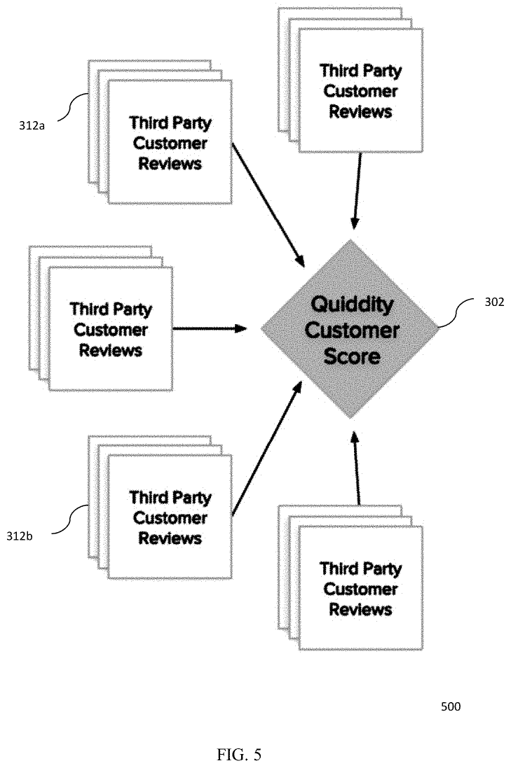

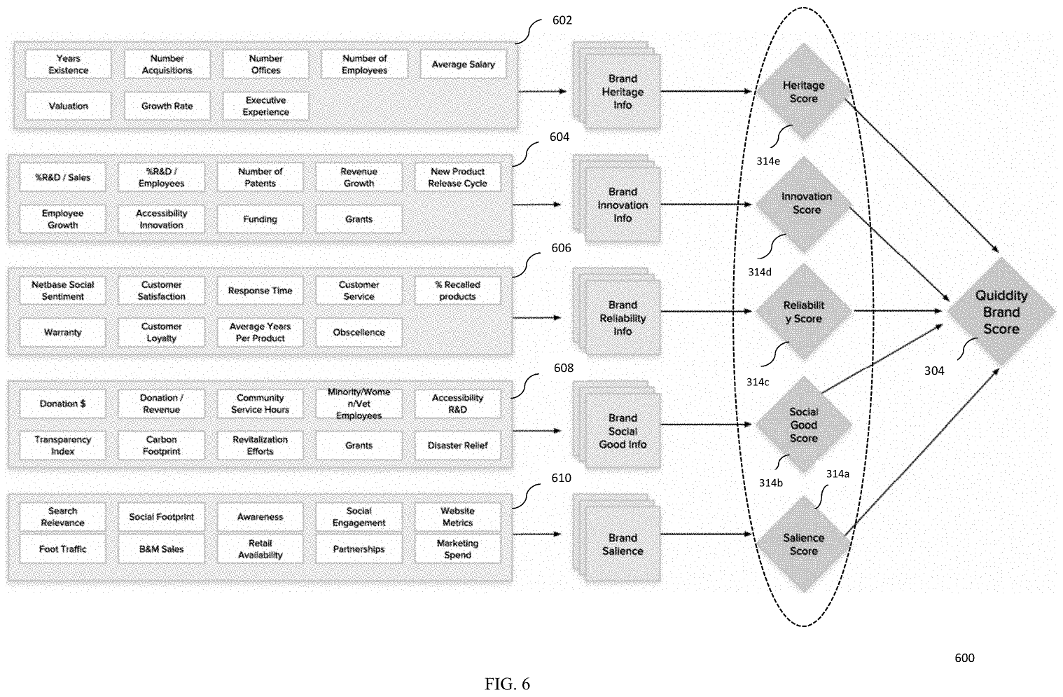

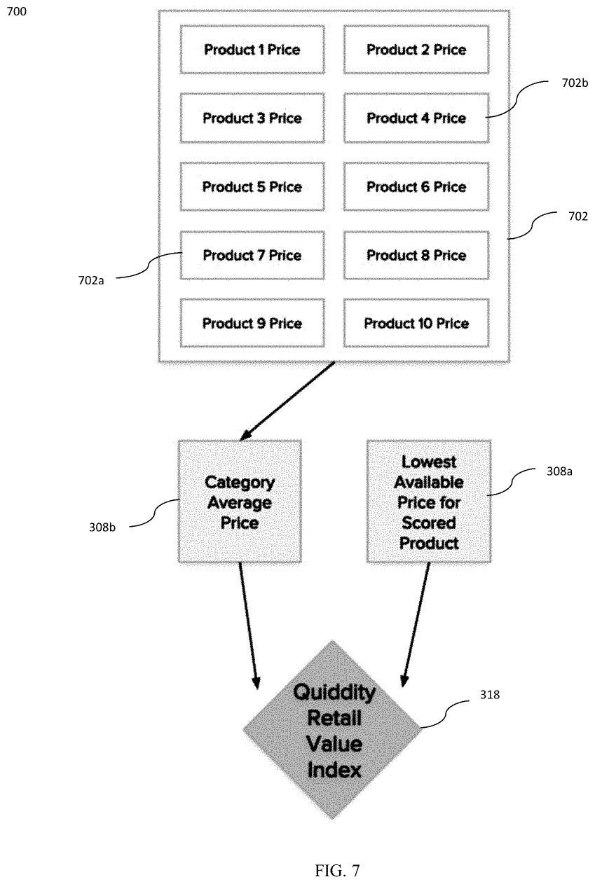

In a preferred embodiment of the invention, with respect to a given product, one or more data sources may contain sets of information about the product's brand, information from experts, information from customers, and retail value. Referring to FIG. 3, these sets of information may be referred to as Brand Data 314, Expert Data 316, Customer Data 312, and Retail Data 318 respectively. Turning now to FIG. 6, the Brand Data, with respect to a given product, may comprise information which facilitates an objective evaluation of a brand with a focus on emotional information including information regarding a brand's heritage 602, innovation 604, reliability 606, social good 608, and salience 610, wherein heritage information 602 reflects a brand's past history and core idea as depicted in current day products and marketing; innovation information 604 reflects a continuous drive to differentiate through improvement of the products, services, processes or experiences offered by the brand (including tangible innovations, such as a new inventions, and intangible ones, such as a new ways of thinking); reliability information 606 reflects the brand's ability to deliver what has been promised and to stand by the quality of its products with a commitment to its customers' satisfaction; social good information 608 reflects a commitment to promote the welfare of others (for example, expressed especially by the generous donation of resources to social initiatives); and salience information 610 reflects the ability to maintain a strong and consistent presence within the marketplace and beyond that includes both pragmatic and emotional importance to the consumer. Turning now to FIG. 4, Expert Data 316, with respect to a given product, may comprise reviews 316a and/or ratings 316b by reputable experts. In a preferred embodiment, the Expert Data comprises third party expert reviews 316a from well-established reputable sources. As seen in FIG. 5, Customer Data, with respect to a given product, may comprise reviews 312a and/or ratings 312b by customers or consumers of the product. In a preferred embodiment, the Customer Data comprises third party customer reviews 312a from well-established retailers. As illustrated in FIG. 7, Retail Data, with respect to a given product, may comprise information regarding the prices 308 of the product available from different sellers and the prices of similar or related products 702 within the same product category.

According to an embodiment of the present invention, each of the Brand Data 314, Expert Data 316, Customer Data 312, and Retail Data 318 have factors or parameters on the basis of which the aggregated qualitative and quantitative data may, via a method described herein, be synthesized and converted by the data synthesis module into a numerical value, namely into a Brand Score 304, Expert Score 306, Customer Score 302, and Retail Value Index 308 respectively. With the Brand Score, Expert Score, Customer Score, and Retail Value Index having been generated, all or some subset of them may be synthesized or combined, via a method described herein, by the data synthesis module to generate the Quid Score™ 301. In a preferred embodiment of the invention, the instructions for converting qualitative and quantitative data sets into a Brand Score, an Expert Score, a Customer Score, or a Retail Value Index as well as for generating a Quid Score™ therefrom are contained in a non-transitory computer readable medium accessible by the data synthesis module. In some embodiments, the data synthesis module may be configured to generate product recommendations 804 based on user input and the Brand Score, Expert Score, Customer Score, Retail Value Index or Quid Score™. In yet other embodiments, the data synthesis module may also be configured to generate lists of the top ten products 802 within each category based at least in part on the Brand Score, Expert Score, Customer Score, Retail Value Index, Quid Score™ or some combination thereof.

In accordance with an embodiment of the invention, the display means is configured to visually display the information generated by the data synthesis module. In a preferred embodiment the data synthesis module may send the Brand Score, Expert Score, Customer Score, Retail Value Index, Quid Score™ or some combination thereof to the display means to be displayed for a user via a communication means linking the data synthesis module to the display means. In a preferred embodiment of the invention, the data synthesis module is distinct from a user's computing device and sends the aforementioned generated scores and information to be displayed via an online web interface or an application interface on a screen or display of the user's computing device.

In accordance with an embodiment of the present invention, the Quid Score™ is generated by synthesizing the Brand Score, Expert Score, Customer Score, and Retail Value Index, or some combination thereof. The Brand Score, Expert Score, Customer Score, and Retail Value Index are respectively generated from the Brand Data, Expert Data, Customer Data, and Retail Data and their respective variables, factors and parameters.

For example, as discussed above, and illustrated in FIG. 6, Brand Data 314 may comprise qualitative and/or quantitative heritage information 602, innovation information 604, reliability information 606, social good information 608, and salience information 608, each of which may be aggregated and synthesized to be converted to a numerical value. In an exemplary embodiment, in order to evaluate a brand's heritage, factors such as the number years the brand has been in existence, the number of acquisitions made by the brand, the number of offices/locations associated with the brand, the size of the company that owns the brand, the number of employees of the company, the salaries paid by the company, the brand's valuation, the brand's growth, and the number of years of experience the executives of the company have may be equated with a numerical heritage value or rating 314e on a predetermined quantitative scale. In an exemplary embodiment, in order to evaluate a brand's innovation, factors such as proportion of the company's revenue from sales spent on research and development, percentage of the company's employees tasked with research and development, the number of patents owned or applied for by the, the company's revenue growth, the company's new product release cycle, the company's employee growth, the brand's accessibility innovation, the company's funding, and/or grants obtained by the company may likewise be equated with a numerical innovation value or rating 314d on a predetermined quantitative scale. In an exemplary embodiment, in order to evaluate a brand's reliability, factors such as its social sentiment (based on the Netbase Sentiment Score), customer satisfaction, response time, customer service, percentage of recalled products, warrant(y/ies) offered, customer loyalty, average product lifetime, and/or old product obsolescence may similarly be equated with a numerical reliability value or rating 314c on a predetermined quantitative scale. In an exemplary embodiment, in order to evaluate a brand's social good, factors such as total amount of charitable donation made, the fraction of revenue distributed as charitable donations, the time and labor spent performing community service, the percentage that members of certain classes of workers (e.g. minorities, women, veterans) comprising the company's total workforce, accessibility research and development, the company's corporate information transparency index, the company's carbon footprint, revitalization efforts, grants, and disaster relief efforts may also be equated with a numerical social good value or rating 314b on a predetermined quantitative scale. Lastly, in an exemplary embodiment, in order to evaluate a brand's salience, factors such as the brand's search relevance, social footprint, awareness, social engagement, visits, recurring foot traffic at retail locations, geographical footprint, non-direct to consumer retail availability, partnerships, sponsorships, marketing expenditures, social velocity, search velocity, virality, and/or posts per month may be equated with a numerical salience value or rating 314a on a predetermined quantitative scale.

An exemplary method by which the aforementioned ratings may be combined and converted into a Brand Score according to an embodiment of the present invention entails assigning a weight factor to each of the respective heritage, innovation, reliability, social good, and relevance rating, multiplying each weight factor by the rating associated with it and then taking the sum of the resulting values. Accordingly, the Brand Score may be calculated from the equation B=wₕ×H+wᵢ×I+wᵣ×R+w_{g}×G+wₛ×S where B is the Brand Score, wₕ is the weight factor given to the heritage rating, H is the heritage rating 314e, wᵢ is the weight factor given to the innovation rating, I is the innovation rating 314d, wᵣ is the weight factor given to the reliability rating, R is the reliability rating 314c, w_{g} is the weight factor given to the social good rating, G is the social good rating 314b, wₛ is the weight factor given to the salience rating, and S is the heritage rating 314a.

Expert Data 316, in accordance with an embodiment of the present invention, may comprise qualitative or quantitative Expert reviews 316a or ratings 316b for a given product. According to an exemplary method of the present invention, an Expert Score 306 for a given product may be generated by, assigning a numerical value on a predetermined standardized quantitative scale for each Expert review and rating available from one or more data source, and obtaining the average of all of the respective values. In other words, the Expert Score may be calculated from the equation E=(Er₁+Er₂+ . . . +Erₙ)/n where Erₙ is the standardized quantitative scale value given to a review 316a or rating 316b from the n^{th} source an n is the total number of expert review and rating sources.

Customer Data 312, in accordance with an embodiment of the present invention, may comprise qualitative or quantitative Customer reviews 312a or ratings 312b for a given product. According to an exemplary method of the present invention, a Customer Score 302 for a given product may be generated by, assigning a numerical value on a predetermined standardized quantitative scale for each Customer review and rating available from one or more data source, and obtaining the average of all of the respective values. In other words, the Customer Score 302 may be calculated from the equation C=(Cr₁+Cr₂+ . . . +Crₙ)/n where Crₙ is the standardized quantitative scale value given to a review 312a or rating 312b from the n^{th} source an n is the total number of customer review and rating sources.

Retail Data 308, in accordance with an embodiment of the present invention, may comprise price information 308a for a given product as well as for other products 308b in the same product category. According to an exemplary method of the present invention, a Retail Value Index 318 for a given product may be generated from the Retail Data 308 by identifying the lowest purchase price available for the product, obtaining the average price for all the products in the same product category, subtracting the lowest purchase price of the product from the average price of all the products, dividing the result by the average price, adding 1 to the result, and dividing the result by a predetermined scaling factor. That is to say that a Retail Value Index 318 for a given product may be calculated from the equation

$$I = \frac{\frac{{P}_{l} - Pa}{Pa} + 1}{1. \overline{3}}$$

where I is the relative price index (assuming that the base level of the index (i.e. when the lowest price available for the product equals the average price of all the products in the category) is 75%, P₁ is the lowest price available for the product, and Pₐ is the average price of all the products in the product category.

Having obtained a Brand Score, an Expert Score, Customer Score, and Retail Value Index, a Quid Score™ can be generated according to embodiments of the present invention. In a preferred embodiment, Quid Score™ may be generated by assigning a weight factor to each of the Brand Score, Expert Score, Customer Score, and Retail Value Index respectively; multiplying each respective weight factor by the score or index to which it is assigned; and adding the resulting values. According to the preferred embodiment of the present invention the sum of the respective weight factors must add up to one in order for the maximum Quid Score™ to be 100%. Accordingly, in the preferred embodiment, the Quid Score™ may be calculated by the formula Q=B×w_{b}+E×wₑ+C×w_{c}+I×wᵢ where Q is the Quid Score™ in percent, B is the Brand Score, w_{b} is the weight factor assigned to the brand score, E is the Expert Score, we is the weight factor assigned to the Expert Score, C is the Customer Score, w_{c} is the weight factor assigned to the Customer Score, I is the Retail Value Index, and wᵢ is the weight factor assigned to the Retail Value Index.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the embodiments.

While multiple embodiments are disclosed, still other embodiments of the present invention will become apparent to those skilled in the art from this detailed description. There may be aspects of this disclosure that may be practiced without the implementation of some features as they are described. The disclosure hereof is capable of myriad modifications in various obvious aspects, all without departing from the spirit and scope of the present invention. Accordingly, the drawings and descriptions are to be regarded as illustrative in nature and not restrictive.

1. A system for facilitating purchasing decisions comprising:
a data source;
a data synthesis module;
a non-transitory computer readable medium;
and a means of displaying visual information to a user.

2. The system of claim 1, wherein the data source is a data server.

3. The system of claim 1, wherein the data source is a hard-drive.

4. The system of claim 1, wherein the data synthesis module comprises:
a processor;
a random access memory circuit; and
a data storage medium.

5. The system of claim 1, wherein the data synthesis module comprises:
a computing device comprising a processor; and
the non-transitory computer readable medium comprising computer program instructions.

6. A system for facilitating purchasing decisions comprising:
a data source;
a data synthesis module;
a means of displaying visual information to a user;
and a non-transitory computer readable medium comprises computer program instructions directing the data synthesis module to perform the steps of:
obtaining a Brand Score;
obtaining an Expert Score;
obtaining a Customer Score;
obtaining a Retail Value Index;
generating a Comprehensive Score based on one or more of the Brand Score, Expert Score, Customer Score, and Retail Value Index;
displaying at least one of a Comprehensive Score, a Top 10 products list within a product category, or a product recommendation to a user.

7. A method for facilitating a purchase decision comprising the steps of:
obtaining a Brand Score;
obtaining an Expert Score;
obtaining a Customer Score;
obtaining a Retail Value Index; and
generating a Comprehensive Score.

8. The method of claim 7, further comprising the step of generating a top 10 product list for a product category.

9. The method of claim 7, further comprising the step of generating at least one product recommendation.

10. The method of claim 8, further comprising the step of displaying the top 10 product list to a user.

11. The method of claim 9, further comprising the step of displaying the at least one product recommendation to a user.

12. The method of claim 7, further comprising the step of displaying the Comprehensive Score to a user.

13. The method of claim 7, further comprising the step of displaying at least one of the Brand Score, the Expert Score, the Customer Score, and the Retail Value Index.

14. The method of claim 7, wherein the step of obtaining the Brand Score comprises the steps of:
assigning a weight factor to each of a heritage rating, an innovation rating, a reliability rating, a social good rating, and a relevance rating;
multiplying each weight factor by the rating associated with it; and
multiplying the sum of the resulting values.

15. The method of claim 7, wherein the step of obtaining the Expert Score comprises the steps of:
assigning a numerical value on a predetermined standardized quantitative scale for each Expert review and rating available from one or more data sources; and
computing the average of the numerical values.

16. The method of claim 7, wherein the step of obtaining the Customer Score comprises the steps of:
assigning a numerical value on a predetermined standardized quantitative scale for each Customer review and rating available from one or more data sources; and
computing the average of the numerical values.

17. The method of claim 7, wherein the step of obtaining the Retail Value Index comprises the steps of:
identifying a lowest purchase price available for a product within a set of price data;
obtaining an average price for all products in the same product category from the set of price data;
subtracting the lowest purchase price of the product from the average price of all the products;
dividing a result of the subtraction by the average price;
adding 1 to a result of the division; and
dividing the result of the summation by a predetermined scaling factor.

18. The method of claim 7, wherein the step of generating the Comprehensive Score comprises the steps of:
assigning a weight factor to each of the Brand Score, the Expert Score, the Customer Score, and the Retail Value Index;
multiplying each respective weight factor by the score or index to which it was assigned; and
adding the values resulting after the multiplication.
